(19) United States
(12) Patent Application Publication
(10) Pub. No.: US 2026/0322303 A1
(43) Pub. Date: Oct. 15, 2026

(54) CONTROL DEVICE, WINDING SWITCHING SYSTEM, VEHICLE, CONTROL METHOD, AND CONTROL PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Masaki TSUDA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/161,551

(22) PCT Filed: Jan. 26, 2024
(86) PCT No.: PCT/JP2024/002516

§ 371 Date: Sep. 2, 2025

(30) Foreign Application Priority Data
Mar. 3, 2023 (JP) 2023-032764

(51) Int. Cl. H02P 27/08; H02P 25/18; H02P 25/22

(52) U.S. Cl. CPC H02P 27/08; H02P 25/188; H02P 25/22

(57) ABSTRACT

A control device for controlling an AC motor includes: a switching command unit that commands a winding switching device that switches the connection state of the plurality of windings, to execute zero crossing switching for switching the connection state of the plurality of windings from the first connection state to the second connection state at a zero crossing point of current flowing through the windings; and a control value switching unit that switches a control value for controlling the AC motor from a first control value to be used for the first connection state to a second control value to be used for the second connection state when the zero crossing switching is executed. The control value switching unit gradually changes the control value from the first control value to the second control value.

### CROSS-REFERENCE TO RELATED APPLICATIONS

This application is the U.S. national stage of PCT/JP2024/002516 filed on Jan. 26, 2024, which claims priority of Japanese Patent Application No. JP 2023-032764 filed on Mar. 3, 2023, the contents of which are incorporated herein.

### TECHNICAL FIELD

The present disclosure relates to a control device, a winding switching system, a vehicle, a control method, and a control program.

### BACKGROUND

Some motors mounted in, for example, electric vehicles are capable of switching between a low-speed, high torque operating state and a high-speed, low-torque operating state by switching connections of a plurality of windings. JP 2020-072632A discloses a device that specifies a period during which an AC motor current is less than or equal to a predetermined value and switches windings during the specified period in order to prevent a surge voltage.

After switching windings of a motor, it is necessary to change a control value such as the duty ratio of a Pulse Width Modulation (PWM) signal. For this reason, not only are the windings switched, but also the control value is switched, and there is a risk of a surge voltage being generated when the control value is switched. Furthermore, a sudden change in the control value may cause the motor current control to oscillate.

### SUMMARY

A control device according to an aspect of the present disclosure is a control device for controlling an AC motor capable of switching a connection state of a plurality of windings from a first connection state to a second connection state, including: a switching command unit configured to command a winding switching device configured to switch the connection state of the plurality of windings, to execute zero crossing switching for switching the connection state of the plurality of windings from the first connection state to the second connection state at a zero crossing point of current flowing through the windings; and a control value switching unit configured to switch a control value for controlling the AC motor from a first control value to be used in the first connection state to a second control value to be used in the second connection state when the zero crossing switching is executed, in which the control value switching unit gradually changes the control value from the first control value to the second control value.

### Advantageous Effects

According to the present disclosure, it is possible to suppress the occurrence of a surge voltage and suppress oscillation of current control of the motor.

### BRIEF DESCRIPTION OF DRAWINGS

FIG. 1 is a diagram showing an example of a configuration of a winding switching system according to a first embodiment.

FIG. 2 is a circuit diagram showing an example of a configuration of a winding switching device according to the first embodiment.

FIG. 3 is a circuit diagram showing an example of a configuration of a control circuit.

FIG. 4 is a timing chart showing an example of transition of states of signals in the winding switching device according to the first embodiment.

FIG. 5 is a block diagram showing an example of a hardware configuration of a control device according to the first embodiment.

FIG. 6 is a functional block diagram showing an example of functions of the control device according to the first embodiment.

FIG. 7 is a control block diagram showing a control system of a motor of the control device according to the first embodiment.

FIG. 8 is a graph showing an example of change of a control voltage value.

FIG. 9 is a flowchart showing an example of motor control processing performed by the control device according to the first embodiment.

FIG. 10 is a circuit diagram showing an example of a configuration of a winding switching device according to a second embodiment.

FIG. 11 is a circuit diagram showing an example of a configuration of a winding switching device according to a third embodiment.

FIG. 12 is a functional block diagram illustrating an example of functions of a control device according to the third embodiment.

FIG. 13 is a flowchart showing an example of motor control processing performed by the control device according to the third embodiment.

### DETAILED DESCRIPTION OF PREFERRED EMBODIMENTS

Hereinafter, an overview of embodiments of the present disclosure will be listed and described.

In a first aspect, a control device according to the present embodiment is a control device for controlling an AC motor capable of switching a connection state of a plurality of windings from a first connection state to a second connection state, including: a switching command unit configured to command a winding switching device configured to switch the connection state of the plurality of windings, to execute zero crossing switching for switching the connection state of the plurality of windings from the first connection state to the second connection state at a zero crossing point of current flowing through the windings; and a control value switching unit configured to switch a control value for controlling the AC motor from a first control value to be used in the first connection state to a second control value to be used in the second connection state when the zero crossing switching is executed, in which the control value switching unit gradually changes the control value from the first control value to the second control value. This makes it possible to prevent the control value from suddenly changing from the first control value to the second control value. Accordingly, it is possible to suppress the occurrence of a surge voltage, and to suppress oscillation of current control of the motor.

In a second aspect according to the first aspect, the AC motor may be a polyphase AC motor, and the control value switching unit may synchronize the change of each of the plurality of control values corresponding to the phases from the first control value to the second control value. This makes it possible to gradually change the control value of each phase from the first control value to the second control value at the same timing.

In a third aspect according to the second aspect, the AC motor may be an n-phase AC motor (n is an integer that is 3 or more), and the control value switching unit may complete the change of each of the n control values from the first control value to the second control value after λ(n−1)/n has elapsed since the start of the change, where λ is a wavelength of the current supplied to the AC motor. This makes it possible to gradually change the control value of each phase from the first control value to the second control value in a period suited to the phase difference of the n-phase alternating current.

In a fourth aspect according to the third aspect, the control value switching unit may start the change of each of the n control values from the first control value to the second control value at a zero crossing point of current of a first phase of the n-phase alternating current. This makes it possible to gradually change the control value of each phase from the first control value to the second control value during the period from the zero crossing point in the first phase to the zero crossing point in the n-th phase.

In a fifth aspect according to the third aspect, the control device may further include a specifying unit configured to specify n switching timings at which the winding switching device executes the zero crossing switching for each of the n phases, in which the control value switching unit may start the change of each of the n control values from the first control value to the second control value at a first switching timing among the n switching timings specified by the specifying unit. This allows the control value of each phase to be gradually changed from the first control value to the second control value during the period from the point in time when zero crossing switching is executed in the first phase to the point in time when zero crossing switching is executed in the n-th phase.

In a sixth aspect according to any one of the first to the fifth aspects, the control device may further include: a parameter value determination unit configured to determine a parameter value of a control parameter to be used for determining the control value; and a control value determination unit configured to determine the control value based on the parameter value determined by the parameter value determination unit, in which the control value determination unit may determine the first control value and the second control value, and the control value switching unit may simultaneously hold the first control value and the second control value determined by the control value determination unit, and switches the control value from the held first control value to the held second control value. This allows the control value switching unit to gradually change the control value for each phase based on the first control value and the second control value that are simultaneously held.

In a seventh aspect according to the sixth aspect, the parameter value determination unit may determine a first parameter value that is a parameter value in the first connection state and a second parameter value that is a parameter value in the second connection state, and the control value determination unit may simultaneously hold the first parameter value and the second parameter value determined by the parameter value determination unit, determines the first control value based on the held first parameter value, and determines the second control value based on the held second parameter value. This allows the control value determination unit to determine the first control value and the second control value, respectively, based on the first parameter value and the second parameter value that are simultaneously held.

In an eighth aspect according to any one of the first to the seventh aspects, the control value may be a voltage value of a voltage to be applied to the windings. This allows the voltage applied to the windings to be gradually changed, making it possible to suppress the occurrence of a surge voltage, and to suppress oscillation of current control.

In a ninth aspect, a winding switching system according to the present embodiment includes: an AC motor capable of switching a connection state of a plurality of windings from a first connection state to a second connection state; a power converter configured to convert power output from a power source into AC power and supply the AC power to the AC motor; a winding switching device configured to execute zero crossing switching for switching the connection state of the plurality of windings from the first connection state to the second connection state at a zero crossing point of current flowing through the windings; and a control device, in which the control device includes: a switching command unit configured to command the winding switching device to execute the zero crossing switching; and a control value switching unit configured to switch a control value for controlling the AC motor from a first control value to be used in the first connection state to a second control value to be used in the second connection state, when the zero crossing switching is executed, and the control value switching unit gradually changes the control value from the first control value to the second control value. This makes it possible to prevent the control value from suddenly changing from the first control value to the second control value. Accordingly, it is possible to suppress the occurrence of a surge voltage, and to suppress oscillation of current control of the motor.

In a tenth aspect, a vehicle according to the present embodiment includes: an AC motor capable of switching a connection state of a plurality of windings from a first connection state to a second connection state; a power converter configured to convert power output from a power source into AC power and supply the AC power to the AC motor; a winding switching device configured to execute zero crossing switching for switching the connection state of the plurality of windings from the first connection state to the second connection state at a zero crossing point of current flowing through the windings; and a control device, in which the control device includes: a switching command unit configured to command the winding switching device to execute the zero crossing switching; and a control value switching unit configured to switch a control value for controlling the AC motor from a first control value to be used in the first connection state to a second control value to be used in the second connection state, when the zero crossing switching is executed, and the control value switching unit gradually changes the control value from the first control value to the second control value. This makes it possible to prevent the control value from suddenly changing from the first control value to the second control value. Accordingly, it is possible to suppress the occurrence of a surge voltage, and to suppress oscillation of current control of the motor.

In an eleventh aspect, a control method according to the present embodiment is a control method for controlling an AC motor capable of switching a connection state of a plurality of windings from a first connection state to a second connection state, including: a step of commanding a winding switching device configured to switch the connection state of the plurality of windings, to execute zero crossing switching for switching the connection state of the plurality of windings from the first connection state to the second connection state at a zero crossing point of current flowing through the windings; and a step of switching a control value for controlling the AC motor from a first control value to be used in the first connection state to a second control value to be used in the second connection state when the zero crossing switching is executed, in which in the step of switching the control value, the control value is gradually changed from the first control value to the second control value. This makes it possible to prevent the control value from suddenly changing from the first control value to the second control value. Accordingly, it is possible to suppress the occurrence of a surge voltage, and to suppress oscillation of current control of the motor.

In a twelfth aspect, a control program according to the present embodiment is a control program for controlling an AC motor capable of switching a connection state of a plurality of windings from a first connection state to a second connection state, the control program causing a computer to execute: a step of commanding a winding switching device configured to switch the connection state of the plurality of windings, to execute zero crossing switching for switching the connection state of the plurality of windings from the first connection state to the second connection state at a zero crossing point of current flowing through the windings; and a step of switching a control value for controlling the AC motor from a first control value to be used in the first connection state to a second control value to be used in the second connection state when the zero crossing switching is executed, in which in the step of switching the control value, the control value is gradually changed from the first control value to the second control value. This makes it possible to prevent the control value from suddenly changing from the first control value to the second control value. Accordingly, it is possible to suppress the occurrence of a surge voltage, and to suppress oscillation of current control of the motor.

The present disclosure can be realized not only as a control device having the above-described characteristic configuration, a winding switching system including the control device, a vehicle including the control device, a control method having steps corresponding to characteristic processing in the control device, and a control program for causing a computer to execute the characteristic processing, but also as a semiconductor integrated circuit that realizes part or all of the control device.

Hereinafter, details of the embodiments of the present disclosure will be described with reference to the drawings. Note that at least some of the embodiments described below may be combined in any manner.

### First Embodiment

### Winding Switching System

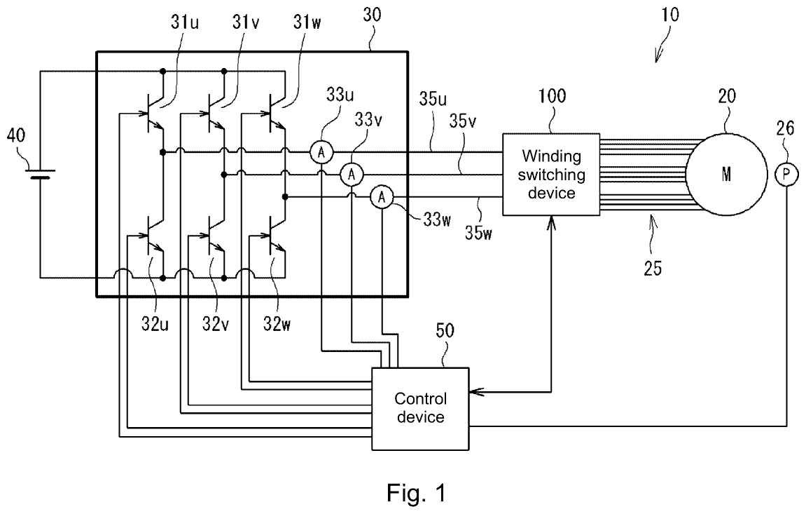

FIG. 1 is a diagram showing an example of a configuration of a winding switching system according to a first embodiment.

The winding switching system 10 is mounted in a vehicle propelled by a motor, such as an electric vehicle or a plug-in hybrid vehicle (hereinafter, referred to as an “electric vehicle”). The winding switching system 10 includes a motor 20, a power converter 30, a battery 40, a control device 50, and a winding switching device 100.

The motor 20 is a travel motor that generates propulsive force for the electric vehicle. The motor 20 is driven by three-phase AC power. An example of the motor 20 is a permanent magnet synchronous motor.

An output shaft of the motor 20 is provided with a position sensor 26. The position sensor 26 detects the rotation angle of the output shaft of the motor 20. The position sensor 26 is, for example, a rotary encoder or a rotary potentiometer. The position sensor 26 is connected to the control device 50 by a signal line. The detection signal of the position sensor 26 is output to the control device 50.

The battery 40 is a battery for supplying power to drive the motor 20. The battery 40 is a secondary battery, and is, for example, a lithium ion battery.

The power converter 30 is an inverter that converts DC power supplied from the battery 40 into three-phase AC power. The power converter 30 may have a function of converting the three-phase AC power output when the motor 20 functions as a generator into DC power and charging the battery 40.

The power converter 30 includes a leg for each of the U-phase, the V-phase, and the W-phase. The U-phase leg includes switches 31u and 32u, the V-phase leg includes switches 31v and 32v, and the W-phase leg includes switches 31w and 32w. The switches 31u, 32u, 31v, 32v, 31w, and 32w perform switching, whereby the DC power is converted into three-phase AC power. The switches 31u, 32u, 31v, 32v, 31w, and 32w are, for example, insulated gate bipolar transistors (IGBTs) or power metal oxide semiconductor field-effect transistors (MOSFETs).

A power line 35u corresponding to the U-phase extends from the U-phase leg, a power line 35v corresponding to the V-phase extends from the V-phase leg, and a power line 35w corresponding to the W-phase extends from the W-phase leg. In the power converter 30, a current sensor 33u is provided on the power line 35u, a current sensor 33v is provided on the power line 35v, and a current sensor 33w is provided on the power line 35w. The current sensor 33u detects the current value of the U-phase current Iu. The current sensor 33v detects the current value of the V-phase current Iv. The current sensor 33w detects the current value of the W-phase current Iw. The current sensors 33u, 33v, and 33w can detect the current values as well as the DC and AC components of the currents Iu, Iv, and Iw flowing through the power lines 35u, 35v, and 35w. The current sensors 33u, 33v, and 33w are, for example, DC current transformers (DCCTs) or shunt resistors.

The current sensors 33u, 33v, and 33w are connected to the control device 50 by signal lines. The detection values of the current sensors 33u, 33v, and 33w are output to the control device 50.

The winding switching device 100 is disposed between the motor 20 and the power converter 30. However, the location of the winding switching device 100 is not limited to between the motor 20 and the power converter 30. The power converter 30 and the winding switching device 100 are connected to each other by the power lines 35u, 35v, and 35w, and the winding switching device 100 and the motor 20 are connected to each other by a plurality of power lines 25. The winding switching device 100 switches the connection state of a plurality of windings of the motor 20. The configuration of the winding switching device 100 will be described later. Three-phase alternating currents output from the power converter 30 are supplied to the motor 20 via the winding switching device 100.

The control device 50 controls the power converter 30 and the winding switching device 100. Specifically, signal lines extend from the control device 50 to each of the switches 31u, 32u, 31v, 32v, 31w, and 32w, and the control device 50 controls the on/off timing of the switches 31u, 32u, 31v, 32v, 31w, and 32w. A signal line extends from the control device 50 to the winding switching device 100, and the control device 50 outputs a switching command signal for commanding switching of the connection state of the windings to the winding switching device 100.

### Configuration of Winding Switching Device

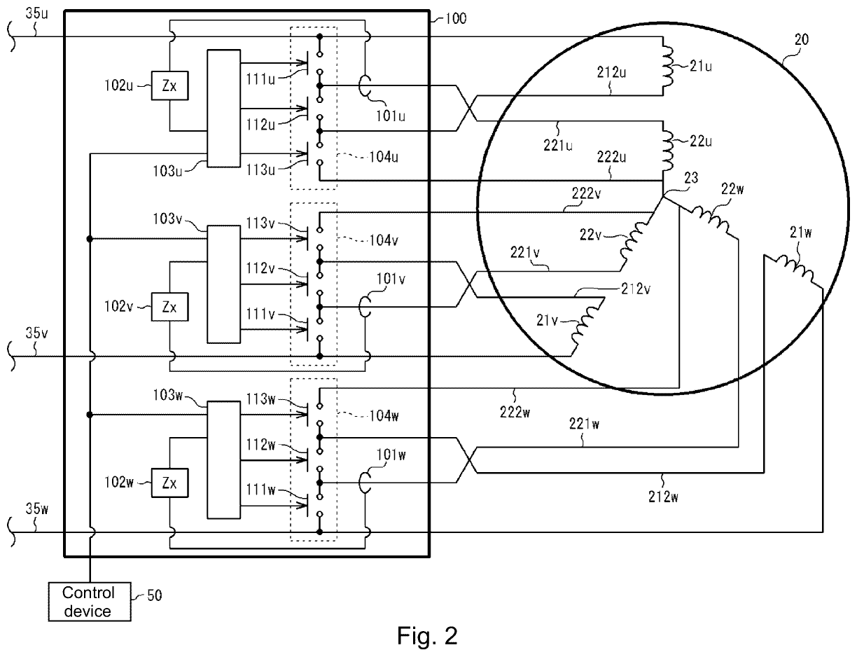

FIG. 2 is a circuit diagram showing an example of the configuration of the winding switching device according to the first embodiment. The motor 20 includes a plurality of windings 21u, 22u, 21v, 22v, 21w, and 22w. The windings 21u and 22u correspond to the U-phase, the windings 21v and 22v correspond to the V-phase, and the windings 21w and 22w correspond to the W-phase. However, the number of windings for each phase is not limited to two, and may be three or more. The windings 22u, 22v, and 22w are connected at a neutral point 23.

The winding switching device 100 switches the connection state of the windings 21u, 22u, 21v, 22v, 21w, and 22w for each phase between a series connection state and a parallel connection state. The winding switching device 100 includes current sensors 101u, 101v, and 101w, zero crossing detection circuits 102u, 102v, and 102w, control circuits 103u, 103v, and 103w, and switching circuits 104u, 104v, and 104w.

The zero crossing detection circuits 102u, 102v, and 102w detect zero crossing points of the measurement values of the current sensors 101u, 101v, and 101w (points in time at which the AC signals output from the current sensors 101u, 101v, and 101w cross the zero reference voltage). In a more specific example, the zero crossing detection circuits 102u, 102v, and 102w compare the output voltages from the current sensors 101u, 101v, and 101w with a zero voltage, and detect points in time when the output voltages from the current sensors 101u, 101v, and 101w coincide with the zero voltage as the zero crossing points. The zero voltage is an example of a reference voltage. The reference voltage is a voltage corresponding to the output voltages of the current sensors 101u, 101v, and 101w when the current flowing through the windings 21u, 22u, 21v, 22v, 21w, and 22w becomes zero, and is not limited to the zero voltage. The zero crossing detection circuits 102u, 102v, and 102w are examples of detection units.

The switching circuits 104u, 104v, and 104w switch the connection state of the windings 21u, 22u, 21v, 22v, 21w, and 22w between a series connection state and a parallel connection state at the timing when the zero crossing detection circuits 102u, 102v, and 102w detect the zero crossing points. The switching circuits 104u, 104v, and 104w are examples of switching units. The series connection state is an example of a first connection state, and the parallel connection state is an example of a second connection state.

Hereinafter, the connection relationship between the winding switching device 100, the power line 35u, and the motor 20 will be described for the U-phase as a representative example. Since the same applies for the V-phase and the W-phase, description thereof is omitted.

The power line 35u is connected to one end of the winding 21u. A power line 212u extends from the other end of the winding 21u. A power line 221u extends from one end of the winding 22u, and a power line 222u extends from the other end.

The switching circuit 104u includes semiconductor relays 111u, 112u, and 113u. The semiconductor relays 111u, 112u, and 113u are, for example, IGBTs or power MOSFETs.

The power line 35u is led into the winding switching device 100. In the winding switching device 100, the power line 35u branches off at an intermediate point and is connected to a first terminal of the semiconductor relay 111u. A second terminal of the semiconductor relay 111u is connected to a first terminal of the semiconductor relay 112u. The power line 221u extending from the winding 22u is connected to a connection point between the second terminal of the semiconductor relay 111u and the first terminal of the semiconductor relay 112u.

A second terminal of the semiconductor relay 112u is connected to a first terminal of the semiconductor relay 113u. The power line 212u extending from the winding 21u is connected to a connection point between the second terminal of the semiconductor relay 112u and the first terminal of the semiconductor relay 113u. A second terminal of the semiconductor relay 113u is connected to the power line 222u extending from the winding 22u.

When the semiconductor relays 111u and 113u are in an off state and the semiconductor relay 112u is in an on state, the windings 21u and 22u are connected in series. When the semiconductor relays 111u and 113u are in an on state and the semiconductor relay 112u is in an off state, the windings 21u and 22u are connected in parallel.

Signal lines extending from the control circuit 103u are respectively connected to the gate terminals of the semiconductor relays 111u, 112u, and 113u.

The power lines 212u, 221u, and 222u extend from the motor 20 and are led into the winding switching device 100. A current sensor 101u is attached to the power line 221u. However, the current sensor 101u may be attached to the power line 35u, 212u, or 222u instead of the power line 221u. The current sensor 101u detects a U-phase current flowing through the power line 221u. The current sensor 101u is, for example, an ACCT that detects only the AC component of a current.

A signal line extending from the current sensor 101u is connected to the zero crossing detection circuit 102u. A signal line that transmits an output signal of the zero crossing detection circuit 102u (hereinafter referred to as a “zero crossing detection signal”) extends from the zero crossing detection circuit 102u to the control circuit 103u. Furthermore, a signal line extending from the control device 50 is connected to the control circuit 103u.

The zero crossing detection circuit 102u detects a zero crossing point of the measurement value of the winding current flowing through the power line 221u, which is measured by the current sensor 101u. The zero crossing detection circuit 102u is a comparator. For example, the inverting input of the comparator is set to a zero reference voltage, and the output signal of the current sensor 101u is applied to the non-inverting input. As a result, at the zero crossing point at which the AC signal output from the current sensor 101u crosses the zero reference voltage, the output of the comparator changes from Low to High.

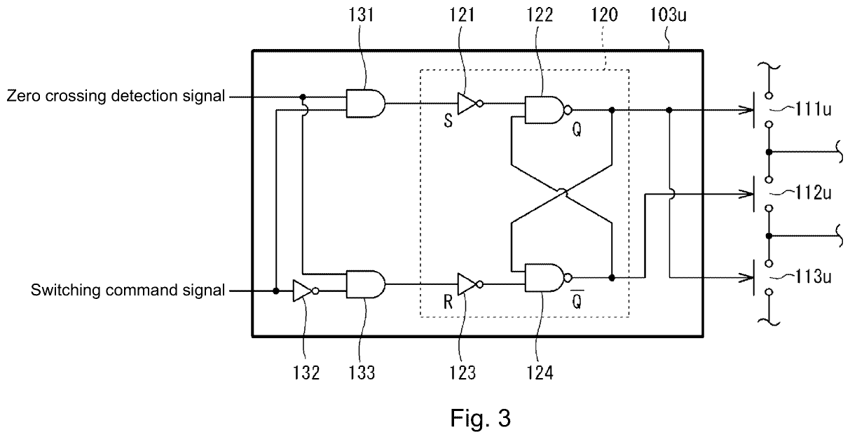

FIG. 3 is a circuit diagram showing an example of the configuration of the control circuit 103u. The control circuit 103u includes AND circuits 131 and 133, a NOT circuit 132, and a latch circuit 120. A signal line extending from the zero crossing detection circuit 102u is connected to a first input terminal of the AND circuit 131 and a first input terminal of the AND circuit 133. A signal line extending from the control device 50 is connected to a second input terminal of the AND circuit 131. Furthermore, the signal line from the control device 50 is connected to an input terminal of the NOT circuit 132. A signal line extending from the output terminal of the NOT circuit 132 is connected to a second input terminal of the AND circuit 133.

The latch circuit 120 is an RS flip-flop. The output terminal of the AND circuit 131 is connected to an input S (set) of the RS flip-flop 120. The output terminal of the AND circuit 133 is connected to an input R (reset) of the RS flip-flop 120. The RS flip-flop 120 includes two NOT circuits 121 and 123 and two NAND circuits 122 and 124. However, the RS flip-flop 120 may be constituted by two NOR circuits.

An output Q of the RS flip-flop 120 is connected to the gates of the semiconductor relays 111u and 113u. An output Q-bar of the RS flip-flop 120 is connected to the gate of the semiconductor relay 112u.

When the signal output from the output Q of the RS flip-flop 120 is Low and the signal output from the output Q-bar of the RS flip-flop 120 is High, the semiconductor relays 111u and 113u are in the off state and the semiconductor relay 112u is in the on state. That is, at this time, the windings 21u and 22u are connected in series. When the signal output from the output Q of the RS flip-flop 120 is High and the signal output from the output Q-bar of the RS flip-flop 120 is Low, the semiconductor relays 111u and 113u are in the on state and the semiconductor relay 112u is in the off state. That is, at this time, the windings 21u and 22u are connected in parallel. When the signal output from the output Q of the RS flip-flop 120 switches from Low to High and the signal output from the output Q-bar of the RS flip-flop 120 switches from High to Low, the semiconductor relays 111u and 113u switch from the off state to the on state, and the semiconductor relay 112u switches from the on state to the off state. That is, the windings 21u and 22u are switched from a series connection state to a parallel connection state. When the signal output from the output Q of the RS flip-flop 120 switches from High to Low and the signal output from the output Q-bar of the RS flip-flop 120 switches from Low to High, the semiconductor relays 111u and 113u switch from the on state to the off state, and the semiconductor relay 112u switches from the off state to the on state. That is, the windings 21u and 22u are switched from a parallel connection state to a series connection state.

### Zero Crossing Switching of Winding Switching Device

Next, the zero crossing switching of the winding switching device 100 will be described. The zero crossing switching is an operation for switching the connection state of the windings 21u, 22u, 21v, 22v, 21w, and 22w between a series connection state and a parallel connection state at the zero crossing points of the winding currents Iu, Iv, and Iw. Note that hereinafter, the switching operation of the connection states of the windings 21u and 22u for the U-phase will be described as a representative example. The V-phase and W-phase are similar, and therefore description thereof will be omitted.

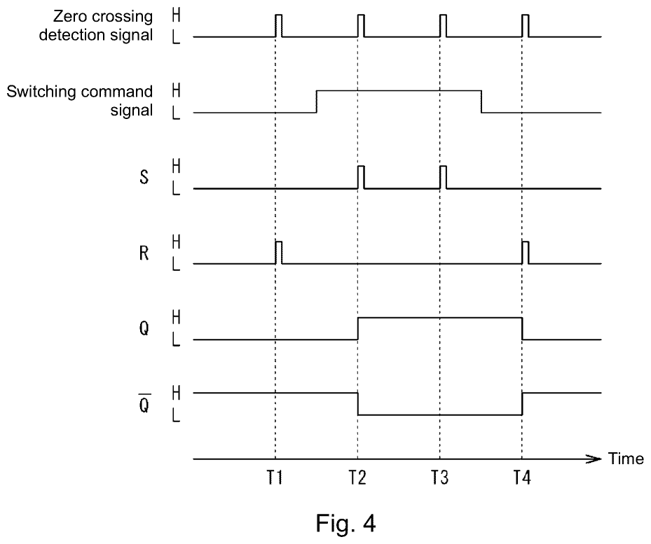

FIG. 4 is a timing chart showing an example of transition of the states of the signals of the winding switching device 100 according to the first embodiment.

The current sensor 101u measures the winding current Iu flowing through the power line 221u. The zero crossing detection circuit 102u detects the zero crossing point of the measurement value of the winding current Iu. That is, the zero crossing detection signal output from the zero crossing detection circuit 102u is Low when the winding current Iu is not zero, and is High at the point in time when the winding current Iu becomes zero. In FIG. 4, the zero crossing detection signal is normally Low and is High at times T1, T2, T3, and T4.

When the windings 21u, 22u, 21v, 22v, 21w, and 22w of the motor 20 are to be connected in series, the control device 50 sets the value of the switching command signal to Low, and when the windings 21u, 22u, 21v, 22v, 21w, and 22w are to be connected in parallel, the control device 50 sets the value of the switching command signal to High. In FIG. 4, the switching command signal is initially Low and changes to High at a point in time between times T1 and T2. The switching command signal changes to Low again at a point in time between times T3 and T4.

The zero crossing detection signal and the switching command signal are input to the AND circuit 131. The AND circuit 131 outputs Low when the zero crossing detection signal and the switching command signal are a combination of (Low, Low), (Low, High), or (High, Low). The AND circuit 131 outputs High when the zero crossing detection signal and the switching command signal are a combination of (High, High). That is, Low is normally input to S of the RS flip-flop 120, and High is input when a zero crossing point of the winding current Iu is detected and a parallel connection command for the windings 21u, 22u, 21v, 22v, 21w, and 22w is given. In FIG. 4, at times T2 and T3, the input signal of S is High.

The zero crossing detection signal and an inverted signal of the switching command signal (the output signal of the NOT circuit 132) are input to the AND circuit 133. The AND circuit 133 outputs Low when the zero crossing detection signal and the switching command signal are a combination of (Low, Low), (Low, High), or (High, High). The AND circuit 133 outputs High when the zero crossing detection signal and the switching command signal are a combination of (High, Low). That is, Low is normally input to R of the RS flip-flop 120, and High is input when a zero crossing point of the winding current Iu is detected and a series connection command for the windings 21u, 22u, 21v, 22v, 21w, and 22w is given. In FIG. 4, the input signal of R is High at times T1 and T4.

The RS flip-flop 120 holds the previous output values of Q and Q-bar when the inputs S and R are Low and Low. In the RS flip-flop 120, when the inputs S and R are Low and High, Q and Q-bar output Low and High, and when the inputs S and R are High and Low, Q and Q-bar output High and Low. In the RS flip-flop 120, a combination in which the inputs S and R are High and High is prohibited.

In the example of FIG. 4, Q is Low and Q-bar is High until time T2. Accordingly, until time T2, the semiconductor relays 111u and 113u are in the off state, and the semiconductor relay 112u is in the on state. For this reason, the windings 21u and 22u are connected in series.

When time T2 arrives, Q changes from Low to High, and Q-bar changes from High to Low. Accordingly, the semiconductor relays 111u and 113u change from the off state to the on state, and the semiconductor relay 112u changes from the on state to the off state. For this reason, the connection state of the windings 21u and 22u switches from the series connection state to the parallel connection state.

From time T2 to T4, Q is High and Q-bar is Low. Therefore, from time T2 to time T4, the semiconductor relays 111u and 113u maintain the on state, and the semiconductor relay 112u maintains the off state. For this reason, the windings 21u and 22u are maintained in the parallel connection state.

When time T4 arrives, Q changes from High to Low, and Q-bar changes from Low to High. Accordingly, the semiconductor relays 111u and 113u change from the on state to the off state, and the semiconductor relay 112u changes from the off state to the on state. For this reason, the connection state of the windings 21u and 22u switches from the parallel connection state to the series connection state.

From time T4 onwards, Q is Low and Q-bar is High. Accordingly, until time T2, the semiconductor relays 111u and 113u maintain the off state, and the semiconductor relay 112u maintains the on state. For this reason, the windings 21u and 22u are maintained in the series connection state.

As described above, the connection state of the windings 21u, 22u, 21v, 22v, 21w, and 22w can be switched between the series connection state and the parallel connection state at the timing of the zero crossing points of the winding currents Iu, Iv, and Iw. Accordingly, the occurrence of a surge voltage is suppressed. Furthermore, there is no need for complex processing to specify the period during which the winding currents Iu, Iv, and Iw are less than or equal to a predetermined value, and the winding switching device 100 can be formed without using a processor such as a CPU, FPGA, or ASIC.

### Hardware Configuration of Control Device

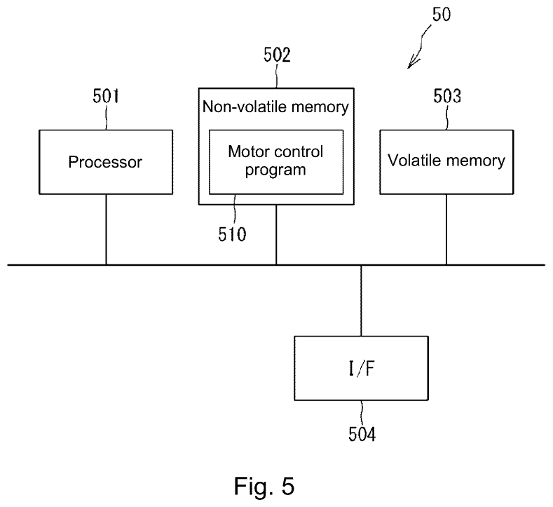

FIG. 5 is a block diagram illustrating an example of a hardware configuration of the control device according to the first embodiment. The control device 50 includes a processor 501, a non-volatile memory 502, a volatile memory 503, and an interface (I/F) 504.

The volatile memory 503 is a semiconductor memory such as a static random access memory (SRAM) or a dynamic random access memory (DRAM). The non-volatile memory 502 is, for example, a flash memory, a hard disk, or a Read Only Memory (ROM). The non-volatile memory 502 stores a motor control program 510, which is a computer program, and data used for executing the motor control program 510. Each function of the control device 50 is realized by the processor 501 executing the motor control program 510. The motor control program 510 can be stored in a recording medium such as a flash memory, a ROM, or a CD-ROM. The processor 501 controls the power converter 30 and the winding switching device 100 according to the motor control program 510.

The processor 501 is, for example, a central processing unit (CPU). However, the processor 501 is not limited to a CPU. The processor 501 may be a graphics processing unit (GPU). The processor 501 is, for example, a multi-core processor. The processor 501 may be a single-core processor. The processor 501 may be, for example, an application specific integrated circuit (ASIC), or a programmable logic device such as a gate array or a field programmable gate array (FPGA). In this case, the ASIC or programmable logic device is configured to be able to execute the same processing as the motor control program 510.

The I/F 504 is connected to the winding switching device 100 and the power converter 30. The I/F 504 is, for example, an input/output interface or a communication interface. For example, the I/F 504 is connected to the current sensors 33u, 33v, and 33w provided in the power converter 30, and can acquire the current value of the U-phase current Iu, the current value of the V-phase current Iv, and the current value of the W-phase current Iw. For example, the I/F 504 is connected to each of the switches 31u, 32u, 31v, 32v, 31w, and 32w of the power converter 30, and can control the switching on and off of the switches 31u, 32u, 31v, 32v, 31w, and 32w. For example, the I/F 504 is connected to the control circuits 103u, 103v, and 103w of the winding switching device 100, and can output a switching command signal to the control circuits 103u, 103v, and 103w.

### Functions of Control Device

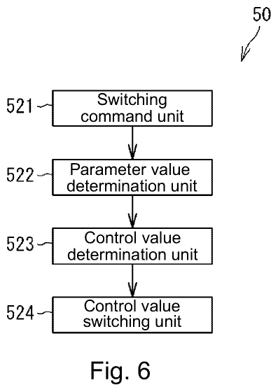

FIG. 6 is a functional block diagram showing an example of functions of the control device according to the first embodiment.

When the processor 501 executes the motor control program 510, the control device 50 executes the functions of a switching command unit 521, a parameter value determination unit 522, a control value determination unit 523, and a control value switching unit 524.

The switching command unit 521 commands the winding switching device 100 to execute zero crossing switching. The command to execute zero crossing switching is issued by outputting a switching command signal to the control circuits 103u, 103v, and 103w. That is, as described above, when a switching command signal is input to the control circuits 103u, 103v, and 103w, a zero crossing detection signal is output from the zero crossing detection circuits 102u, 102v, and 102w at the point in time at which the next zero crossing point is detected, and zero crossing switching is executed.

The parameter value determination unit 522 determines the parameter values of the control parameters used for determining the voltages (hereinafter also referred to as “control voltage values”) to be applied to the windings 21u, 22u, 21v, 22v, 21w, and 22w. Specifically, the parameter value determination unit 522 determines the parameter values of the control parameters in the following control system.

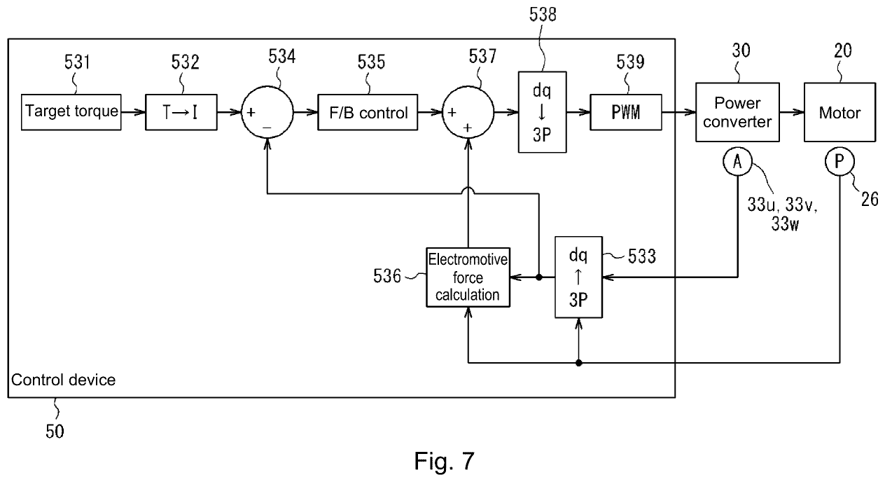

FIG. 7 is a control block diagram showing a control system of a motor of a control device according to the first embodiment. Hereinafter, the determination of the parameter values of the control parameters will be described with reference to FIG. 7.

The control device 50 sets a target torque 531 for the motor 20. The target torque 531 is calculated from, for example, a target speed or the like of the vehicle.

The target torque 531 is input to a torque-current conversion unit 532. The torque-current conversion unit 532 converts the target torque 531 into a target current. The conversion from the target torque 531 to the target current is performed based on the output characteristics of the motor 20 stored in advance in the control device 50. For example, the output characteristics when the windings 21u, 22u, 21v, 22v, 21w, and 22w are in the series connection state are different from the output characteristics when the windings 21u, 22u, 21v, 22v, 21w, and 22w are in the parallel connection state. For example, the non-volatile memory 502 of the control device 50 stores two types of output characteristics, namely the output characteristics when the windings 21u, 22u, 21v, 22v, 21w, and 22w are in the series connection state, and the output characteristics when the windings 21u, 22u, 21v, 22v, 21w, and 22w are in the parallel connection state. The torque-current conversion unit 532 determines a target current in accordance with output characteristics corresponding to the connection state of the windings 21u, 22u, 21v, 22v, 21w, and 22w at that point in time. The target current obtained by the torque current conversion unit 532 is a current value in the dq coordinate system (hereinafter also referred to as a “dq current value”; a voltage value in the dq coordinate system is also referred to as a “dq voltage value”).

The detection values of the current sensors 33u, 33v, and 33w and the detection value of the position sensor 26 are input to a current conversion unit 533. The current conversion unit 533 converts the current value of each phase of the three-phase alternating current into a dq current value. The current conversion unit 533 outputs the detection values of the current sensors 33u, 33v, and 33w, that is, the dq current values corresponding to the winding currents Iu, Iv, and Iw.

At a summing point 534, the difference between the target current output from the torque-current conversion unit 532 and the winding current output from the current conversion unit 533 is calculated. The calculated difference is input to an F/B control unit 535.

The F/B control unit 535 calculates a feedback gain based on the difference between the input target current and the winding current. For example, the correspondence relationship between the difference and the feedback gain is determined in advance. For example, two types of correspondence relationships are determined, namely a correspondence relationship when the windings 21u, 22u, 21v, 22v, 21w, and 22w are in the series connection state, and a correspondence relationship when the windings 21u, 22u, 21v, 22v, 21w, and 22w are in the parallel connection state. The F/B control unit 535 determines a feedback gain from the difference according to the correspondence relationship corresponding to the connection state of the windings 21u, 22u, 21v, 22v, 21w, and 22w at that time. The feedback gain is a portion of the drive voltage of the motor 20.

The F/B control unit 535 determines the feedback gain according to a predetermined control method. For example, the F/B control unit 535 can determine the feedback gain according to any one of P control (proportional control), PI control (proportional integral control), PD control (proportional differential control), and PID control (proportional integral differential control). The above-mentioned correspondence relationship is determined according to such a control method.

The winding current output from the current conversion unit 533 and the detection value of the position sensor 26 are input to an electromotive force calculation unit 536. Based on the winding current and the rotational speed of the motor 20, the electromotive force calculation unit 536 calculates a control component obtained based on the induced voltage generated in the motor 20, such as a control component for decoupling control of the alternating current of the motor 20, mutual inductance between the d-axis and q-axis, and the like. The induced voltage differs between when the windings 21u, 22u, 21v, 22v, 21w, and 22w are in the series connection state and when they are in the parallel connection state. Accordingly, the electromotive force calculation unit 536 calculates a control component obtained based on the induced voltage corresponding to the connection state of the windings 21u, 22u, 21v, 22v, 21w, and 22w at that time.

The decoupling control will be described hereinafter.

A state equation (differential equation) of an eternal magnet synchronous motor in the d-q coordinate system is expressed by Formula (1).

$$[ Math . 1 ]$$

$$p [ \begin{matrix}{i}_{d} \\ {i}_{q}\end{matrix} ] = [ \begin{matrix}- \frac{{R}_{a}}{{L}_{d}} & \frac{ω {L}_{q}}{{L}_{d}} \\ - \frac{ω {L}_{d}}{{L}_{q}} & - \frac{{R}_{a}}{{L}_{q}}\end{matrix} ] [ \begin{matrix}{i}_{d} \\ {i}_{q}\end{matrix} ] + [ \begin{matrix}\frac{1}{{L}_{d}} & 0 \\ 0 & \frac{1}{{L}_{q}}\end{matrix} ] [ \begin{matrix}{v}_{d} \\ {v}_{q}\end{matrix} ] - [ \begin{matrix}0 \\ \frac{{ωΨ}_{a}}{{L}_{q}} ]\end{matrix} \qquad ( 1 )$$

$${pi}_{a} = {A}_{e} {i}_{a} + {B}_{e} {v}_{a} + {d}_{e} \qquad ( {1}^{′} )$$

Here, ia=[id,iq]^{T} is the armature current (winding current), va=[vd,vq]^{T} is the armature voltage, w is the angular velocity of the motor, Ψa is the magnet magnetic flux, Ra is the winding resistance, Ld and Lq are the winding inductances, and p is the differential symbol.

In decoupling control, the influence of interference terms between the d and q axes due to induced electromotive force is eliminated. Specifically, the d-axis and q-axis voltages are corrected as shown in the following Formula (2).

$$[ Math . 2 ]$$

$$\begin{matrix}{v}_{d} = {v}_{d}^{′} + {v}_{o d} = {v}_{d}^{′} - ω {L}_{q} {i}_{q} \\ {v}_{q} = {v}_{q}^{′} + {v}_{o q} = {v}_{q}^{′} + ω ( {Ψ}_{a} + {L}_{d} {i}_{d} )\end{matrix} \} \qquad ( 2 )$$

Here, vod is the d-axis component of the induced electromotive force, and voq is the q-axis component of the induced electromotive force.

By substituting Formula (2) into Formula (1), the following Formula (3) in which v′a=[v′d,v′q] is a new input is derived.

$$[ Math . 3 ]$$

$$p [ \begin{matrix}{i}_{d} \\ {i}_{q}\end{matrix} ] = [ \begin{matrix}- \frac{{R}_{a}}{{L}_{d}} & 0 \\ 0 & - \frac{{R}_{a}}{{L}_{q}}\end{matrix} ] [ \begin{matrix}{i}_{d} \\ {i}_{q}\end{matrix} ] + [ \begin{matrix}\frac{1}{{L}_{d}} & 0 \\ 0 & \frac{1}{{L}_{q}}\end{matrix} ] [ \begin{matrix}{v}_{d}^{′} \\ {v}_{q}^{′}\end{matrix} ] \qquad ( 3 )$$

$${pi}_{a} = {A}_{e}^{′} {i}_{a} + {B}_{e} {v}_{a}^{′} \qquad ( {3}^{′} )$$

From Formula (3), it can be understood that the d-axis and q-axis can be decoupled and a disturbance de can be cancelled.

The feedback gain output from the F/B control unit 535 and the control component output from the electromotive force calculation unit 536 are input to a summing point 537. The summing point 537 adds the feedback gain output from the F/B control unit 535 and the control component output from the electromotive force calculation unit 536 to calculate a control voltage value. The control voltage value is an example of a “control value”.

The control voltage value is input to a voltage conversion unit 538. The voltage conversion unit 538 converts the dq voltage value into a three-phase AC voltage.

The control voltage value of the three-phase AC voltage output from the voltage conversion unit 538 is input to a PWM unit 539. The PWM unit 539 determines a duty ratio corresponding to the input control voltage value, and generates PWM signals for driving each of the switches 31u, 32u, 31v, 32v, 31w, and 32w of the power converter 30 according to the determined duty ratio. The PWM unit 539 outputs the generated PWM signal to each of the switches 31u, 32u, 31v, 32v, 31w, and 32w.

The description returns to FIG. 6. The control parameters include a target current, a feedback gain, and a control component obtained based on an induced voltage. The parameter value determination unit 522 can determine the target current in the series connection state of the windings 21u, 22u, 21v, 22v, 21w, and 22w, the target current in the parallel connection state, the feedback gain in the series connection state, the feedback gain in the parallel connection state, the control component obtained based on the induced voltage in the series connection state, and the control component obtained based on the induced voltage in the parallel connection state. In other words, when the windings 21u, 22u, 21v, 22v, 21w, and 22w are connected in series, the parameter value determination unit 522 determines the target current in the series connection state, the feedback gain in the series connection state, and the control component obtained based on the induced voltage in the series connection state. When the windings 21u, 22u, 21v, 22v, 21w, and 22w are connected in parallel, the parameter value determination unit 522 determines a target current in the parallel connection state, a feedback gain in the parallel connection state, and a control component obtained based on the induced voltage in the parallel connection state.

The control value determination unit 523 determines the control voltage value. Specifically, the control value determination unit 523 can add the feedback gain determined by the parameter value determination unit 522 and a control component obtained based on the induced voltage to calculate the control voltage value. The control value determination unit 523 determines a control voltage value in the series connection state of the windings 21u, 22u, 21v, 22v, 21w, and 22w, and a control voltage value in the parallel connection state of the windings 21u, 22u, 21v, 22v, 21w, and 22w. That is, the control value determination unit 523 adds the feedback gain in the series connection state of windings 21u, 22u, 21v, 22v, 21w, and 22w to the control component obtained based on the induced voltage in the series connection state to calculate a control voltage value in the series connection state. The control value determination unit 523 adds the feedback gain in the parallel connection state of the windings 21u, 22u, 21v, 22v, 21w, and 22w to a control component obtained based on the induced voltage in the parallel connection state, and calculates a control voltage value in the parallel connection state.

For example, in the same control cycle, the parameter value determination unit 522 may determine the target current, the feedback gain, and the control component obtained based on the induced voltage in the series connection state of the windings 21u, 22u, 21v, 22v, 21w, and 22w, and the target current, the feedback gain, and the control component obtained based on the induced voltage in the parallel connection state of the windings 21u, 22u, 21v, 22v, 21w, and 22w. Here, the control cycle refers to a control sequence in the above-mentioned control system, from when a PWM duty ratio is determined and a PWM signal is output, to when the next duty ratio is determined and the next PWM signal is output.

In a specific example, when zero crossing switching is about to be executed, the parameter value determination unit 522 can determine the target current, feedback gain, and control component obtained based on the induced voltage in the series connection state of the windings 21u, 22u, 21v, 22v, 21w, and 22w, and the target current, feedback gain, and control component obtained based on the induced voltage in the parallel connection state of the windings 21u, 22u, 21v, 22v, 21w, and 22w, in the same control cycle. For example, when a gear shift command from a gear shift command device (not shown) is given to the control device 50, the control device 50 determines that zero crossing switching is to be executed in response to the gear shift command. In this case, the control device 50 can judge that zero crossing switching is about to be executed. In a specific example, when a switching command signal is output to the winding switching device 100, the parameter value determination unit can determine the target current, feedback gain, and control component obtained based on the induced voltage in the series connection state of the windings 21u, 22u, 21v, 22v, 21w, and 22w, and the target current, feedback gain, and control component obtained based on the induced voltage in the parallel connection state of the windings 21u, 22u, 21v, 22v, 21w, and 22w, in the same control cycle. During the period from when the zero crossing switching is executed and the control voltage value is switched as described below until when the next switching command signal is output, the parameter value determination unit 522 can determine only the target current, feedback gain, and control component obtained based on the induced voltage in the connection state (series connection state or parallel connection state) of the windings 21u, 22u, 21v, 22v, 21w, and 22w at that time.

For example, the control value determination unit 523 can simultaneously hold the feedback gain and control component obtained based on the induced voltage in the series connection state of the windings 21u, 22u, 21v, 22v, 21w, and 22w and the feedback gain and control component obtained based on the induced voltage in the parallel connection state of the windings 21u, 22u, 21v, 22v, 21w, and 22w, all of which were determined by the parameter value determination unit 522. That is, the control value determination unit 523 can hold the feedback gain and control component obtained based on the induced voltage in the series connection state of the windings 21u, 22u, 21v, 22v, 21w, and 22w, and the feedback gain and control component obtained based on the induced voltage in the parallel connection state of the windings 21u, 22u, 21v, 22v, 21w, and 22w, all of which were determined by the parameter value determination unit 522, in the same control cycle (the control cycle in which these parameter values were determined).

The control value determination unit 523 can determine a control voltage value in the series state by adding up the held feedback gain and control component obtained based on the induced voltage in the series state, and can determine a control voltage value in the parallel state by adding up the held feedback gain and control component obtained based on the induced voltage in the parallel state. That is, the control value determination unit 523 can determine the control voltage value in the series connection state and the control voltage value in the parallel connection state in the same control cycle.

In a specific example, when zero crossing switching is about to be executed, that is, when it has been determined that zero crossing switching is to be executed and a switching command signal has been output, the control value determination unit 523 can determine the control voltage value in the series connection state of the windings 21u, 22u, 21v, 22v, 21w, and 22w and the control voltage value in the parallel connection state of the windings 21u, 22u, 21v, 22v, 21w, and 22w in the same control cycle. During the period from when the zero crossing switching is executed and the control voltage value is switched as described below until when the next switching command signal is output, the control value determination unit 523 can determine only the control voltage value in the connection state (series connection state or parallel connection state) of the windings 21u, 22u, 21v, 22v, 21w, and 22w at that time.

When zero crossing switching is to be executed, the control value switching unit 524 switches the control voltage value between a control voltage value to be used in the series connection state (a control voltage value in the series connection state) and a control voltage value to be used in the parallel connection state (a control voltage value in the parallel connection state). Specifically, when the series connection state is switched to the parallel connection state through zero crossing switching, the control value switching unit 524 switches the control voltage value from the control voltage value in the series connection state to the control voltage value in the parallel connection state. When the parallel connection state is switched to the series connection state through zero crossing switching, the control value switching unit 524 switches the control voltage value from the control voltage value in the parallel connection state to the control voltage value in the series connection state. Hereinafter, the control voltage value in the connection state before switching is referred to as a “first control voltage value”, and the control voltage value in the connection state after switching is referred to as a “second control voltage value”.

The control value switching unit 524 gradually changes the control voltage value from the first control voltage value to the second control voltage value. In a specific example, the control value switching unit 524 changes the control voltage value from the first control voltage value to the second control voltage value in a ramp shape over time.

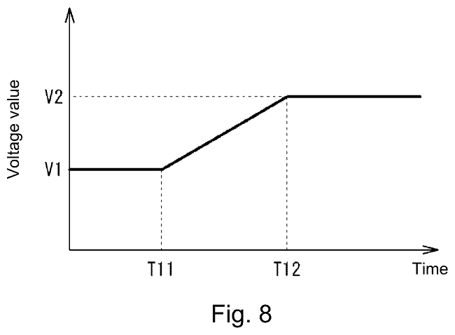

FIG. 8 is a graph showing an example of change of the control voltage value. In FIG. 8, the vertical axis indicates the voltage value (effective value) of the U-phase, and the horizontal axis indicates time. Note that the same applies also for the V-phase and the W-phase.

Until time T11, the PWM signal for applying the first control voltage value V1 to the windings 21u and 22u is output. The control value switching unit 524 changes the control voltage value in a ramp shape from the first control voltage value V1 to the second control voltage value V2 during the period from time T11 to time T12 (hereinafter also referred to as the “switching period”). That is, part of the way through the switching period, the control voltage value takes a value between the first control voltage value V1 and the second control voltage value V2. In the example of FIG. 8, the second control voltage value V2 is higher than the first control voltage value V1. For this reason, during the switching period, the control voltage value gradually increases from the first control voltage value to the second control voltage value. By changing the control voltage value in this manner, it is possible to suppress the occurrence of a surge voltage due to switching of the control voltage value, and to suppress oscillation of the current control.

Note that the gradual change of the control voltage value is not limited to ramp-shaped change. For example, the control voltage value may be changed in a curved manner.

Here, gradually changing the control voltage value includes changing the control voltage value in a stepwise manner. That is, gradually changing the control voltage value is not limited to smoothly changing the control voltage value over time. For example, the control voltage value may also be changed in multiple steps or discretely.

Returning to FIG. 6, for example, the control value switching unit 524 synchronizes the change of the U-phase control voltage value, the V-phase control voltage value, and the W-phase control voltage value from the first control voltage value to the second control voltage value. “Synchronization” in this context means that the change of the control voltage value of the U-phase, the control voltage value of the V-phase, and the control voltage value of the W-phase starts at the same timing, and that the change of the control voltage value of the U-phase, the control voltage value of the V-phase, and the control voltage value of the W-phase is completed at the same timing. That is, the control voltage value of the U-phase, the control voltage value of the V-phase, and the control voltage value of the W-phase each start to change from the first control voltage value at the same timing (the start of the switching period) and reach the second control voltage value at the same timing (the end of the switching period).

In a specific example, when the winding current is n-phase alternating current (where n is an integer that is 3 or more), the control value switching unit 524 completes the change of each of the n control voltage values from the first control voltage value to the second control voltage value after λ(n−1)/n has elapsed since the change started. Here, λ is the period of the winding current. In this embodiment, n=3 holds true. For example, the phase of the V-phase current is shifted 2π/3 from the phase of the U-phase current, and the phase of the W-phase current is shifted 4π/3 from the phase of the U-phase current. A point on the V-phase current corresponding to one point on the waveform of the U-phase current is a point located λ/3 after the one point on the waveform of the U-phase current, and a point on the W-phase current corresponding to one point on the waveform of the U-phase current is a point located 2λ/3 after the one point on the waveform of the U-phase current. Accordingly, by changing the control voltage values of the U-phase, V-phase, and W-phase as described above, the switching period can be adapted to the phase difference between the winding currents Iu, Iv, and Iw.

In a specific example, the control value switching unit 524 starts changing each of the n control voltage values from the first control voltage value to the second control voltage value at a zero crossing point in the U-phase current. This allows the change of the control voltage value of each phase to be started at the zero crossing point of the U-phase current, and be completed at the zero crossing point of the W-phase current.

For example, the control value switching unit 524 simultaneously holds the first control voltage value and the second control voltage value determined by the control value determination unit 523. The control value switching unit 524 switches the control voltage value from the held first control voltage value to the held second control voltage value. The control value switching unit 524 can determine how to change the control voltage value from the first control voltage value to the second control voltage value by holding the first control voltage value and the second control voltage value simultaneously (i.e., in the same control cycle).

### Operations of Control Device

Next, operations of the control device 50 will be described. The control device 50 executes motor control processing by the processor 501 executing a motor control program 510.

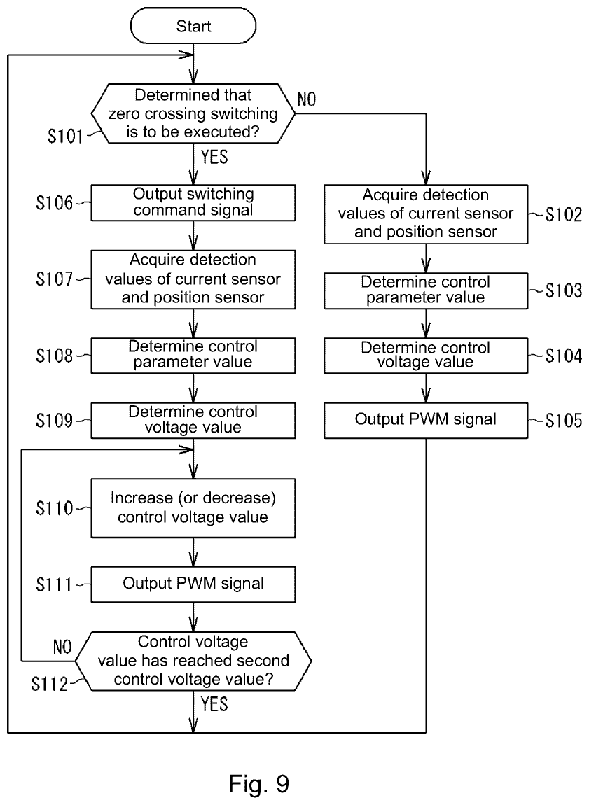

FIG. 9 is a flowchart showing an example of motor control processing performed by the control device according to the first embodiment.

For example, when a gear shift instruction is given to the control device 50, the processor 501 determines that zero crossing switching is to be executed. The processor 501 judges whether or not it has been determined that zero crossing switching is to be executed (step S101).

If it has not been determined that zero crossing switching is to be executed (NO in step S101), the processor 501 acquires the detection values output from the current sensors 33u, 33v, and 33w and the detection value output from the position sensor 26 (step S102). The processor 501 calculates the rotation speed of the motor 20 based on the detection value from the position sensor 26.

The processor 501 determines parameter values of control parameters corresponding to the connection states of the windings 21u, 22u, 21v, 22v, 21w, and 22w at that time based on the acquired current values of the winding currents Iu, Iv, Iw and the rotational speed of the motor 20 (step S103). The control parameters include a control component obtained based on a target current, a feedback gain, and an induced voltage.

The processor 501 determines control voltage values corresponding to the connection states of the windings 21u, 22u, 21v, 22v, 21w, and 22w at that time based on the determined parameter values (step S104).

The processor 501 determines a duty ratio based on the determined control voltage value, and outputs a PWM signal having the determined duty ratio (step S105). The switches 31u, 32u, 31v, 32v, 31w, and 32w are driven in accordance with the PWM signal, and the motor 20 is supplied with the winding currents Iu, Iv, and Iw. After step S105, the processor 501 returns to step S101.

If it has been determined that zero crossing switching is to be executed (YES in step S101), the processor 501 outputs a switching command signal to the winding switching device 100 (step S106). Next, the processor 501 acquires the detection values output from the current sensors 33u, 33v, and 33w and the detection value output from the position sensor 26 (step S107). The processor 501 calculates the rotation speed of the motor 20 based on the detection value from the position sensor 26.

The processor 501 determines parameter values corresponding to the series state of the windings 21u, 22u, 21v, 22v, 21w, and 22w and parameter values corresponding to the parallel state based on the acquired current values of the winding currents Iu, Iv, and Iw and the rotational speed of the motor 20 (step S108). That is, the processor 501 determines a target current for each of the series connection state and the parallel connection state, a feedback gain for each of the series connection state and the parallel connection state, and a control component obtained based on the induced voltage for each of the series connection state and the parallel connection state.

The processor 501 determines the control voltage value in the series connection state and the control voltage value in the parallel connection state based on the determined parameter values (step S109).

The processor 501 changes the control voltage value used to generate the PWM signal by a predetermined amount (step S110). That is, when the series connection state is switched to the parallel connection state through zero crossing switching, the processor 501 increases (or decreases) the control voltage value by a predetermined amount to switch from the control voltage value in the series connection state (first control voltage value) to the control voltage value in the parallel connection state (second control voltage value). When the parallel connection state is switched to the series connection state through zero crossing switching, the processor 501 increases (or decreases) the control voltage value by a predetermined amount to switch from the control voltage value in the parallel connection state (first control voltage value) to the control voltage value in the series connection state (second control voltage value).

The processor 501 determines the duty ratio based on the control voltage value after the change by a predetermined amount, and outputs a PWM signal with the determined duty ratio (step S111). The switches 31u, 32u, 31v, 32v, 31w, and 32w are driven in accordance with the PWM signal, and the motor 20 is supplied with the winding currents Iu, Iv, and Iw.

The processor 501 judges whether or not the control voltage value has reached the second control voltage value (step S112). If the control voltage value has not reached the second control voltage value (NO in step S112), the processor 501 returns to step S110. By repeating steps S110 to S112, the control voltage value gradually changes from the first control voltage value to the second control voltage value.

When the control voltage value reaches the second control voltage value (YES in step S112), the switching of the control voltage value from the first control voltage value to the second control voltage value is complete. In this case, the processor 501 returns to step S101.

### Second Embodiment

The winding switching device of the second embodiment switches the connection state of a plurality of windings of a motor between a full connection state in which all of the plurality of windings are connected, and a partial connection state in which some of the plurality of windings are connected.

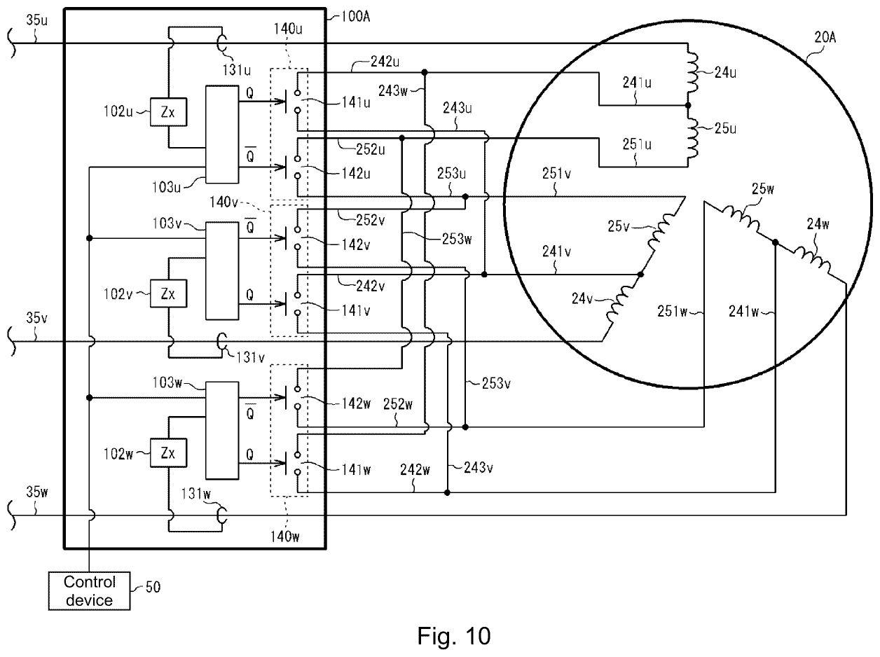

FIG. 10 is a circuit diagram showing an example of a configuration of a winding switching device according to a second embodiment. A motor 20A includes a plurality of windings 24u, 25u, 24v, 25v, 24w, and 25w. The windings 24u and 25u correspond to a U-phase, the windings 24v and 25v correspond to a V-phase, and the windings 24w and 25w correspond to a W-phase. However, the number of windings for each phase is not limited to two, and may be three or more.

A winding switching device 100A switches the connection state of the windings 24u, 25u, 24v, 25v, 24w, and 25w for each phase between a full connection state and a partial connection state. The winding switching device 100A includes current sensors 131u, 131v, and 131w, zero crossing detection circuits 102u, 102v, and 102w, control circuits 103u, 103v, and 103w, and switching circuits 140u, 140v, and 140w.

The zero crossing detection circuits 102u, 102v, and 102w detect zero crossing points of the measurement values of the current sensors 131u, 131v, and 131w. The configuration of the zero crossing detection circuits 102u, 102v, and 102w is similar to that of the first embodiment, and therefore description thereof is omitted.

The switching circuits 140u, 140v, 140w switch the connection state of the windings 24u, 25u, 24v, 25v, 24w, 25w between the full connection state and the partial connection state when the zero crossing detection circuits 102u, 102v, and 102w detect a zero crossing point. The switching circuits 140u, 140v, and 140w are an example of a switching unit. The full connection state is an example of a first connection state, and the partial connection state is an example of a second connected state.

A power line 35u is connected to one end of the winding 24u. The other end of the winding 24u and one end of the winding 25u are connected to each other, and a power line 241u extends from an intermediate point between the windings 24u and 25u. The power line 241u branches into power lines 242u and 243w. A power line 251u extends from the other end of the winding 25u. The power line 251u branches into power lines 252u and 253w.

A power line 35v is connected to one end of the winding 24v. The other end of the winding 24v and the one end of the winding 25v are connected to each other, and a power line 241v extends from an intermediate point between the windings 24v and 25v. The power line 241v branches into power lines 242v and 243u. A power line 251v extends from the other end of the winding 25v. The power line 251v branches into power lines 252v and 253u.

A power line 35w is connected to one end of the winding 24w. The other end of the winding 24w and one end of the winding 25w are connected to each other, and a power line 241w extends from an intermediate point between the windings 24w and 25w. The power line 241w branches into power lines 242w and 243v. A power line 251w extends from the other end of the winding 25w. The power line 251w branches into power lines 252w and 253v.

The switching circuit 140u includes semiconductor relays 141u and 142u. The switching circuit 140v includes semiconductor relays 141v and 142v. The switching circuit 140w includes semiconductor relays 141w and 142w. The semiconductor relays 141u, 142u, 141v, 142v, 141w, and 142w are, for example, IGBTs or power MOSFETs.

In the switching circuit 140u, a first terminal of the semiconductor relay 141u is connected to the power line 242u, and a second terminal of the semiconductor relay 141u is connected to the power line 243u. A first terminal of the semiconductor relay 142u is connected to the power line 252u, and a second terminal of the semiconductor relay 142u is connected to the power line 253u. The connection relationships of the switching circuits 140v and 140w are similar to that of the switching circuit 140u, and therefore description thereof is omitted.

When the semiconductor relays 141u, 141v, and 141w are in the off state and the semiconductor relays 142u, 142v, and 142w are in the on state, the full connection state is entered in which all of the windings 24u, 25u, 24v, 25v, 24w, and 25w are connected. When the semiconductor relays 141u, 141v, and 141w are in the on state and the semiconductor relays 142u, 142v, and 142w are in the off state, the partial connection state is entered in which only the windings 24u, 24v, and 24w are connected among the windings 24u, 25u, 24v, 25v, 24w, and 25w.

The power line 35u is led into the winding switching device 100A. The current sensor 131u is attached to the power line 35u. The current sensor 131u detects a U-phase current flowing through the power line 35u. The current sensor 131u is, for example, an ACCT that detects only the AC component of a current. A signal line extending from the current sensor 131u is connected to the zero crossing detection circuit 102u. The same applies for the V-phase and the W-phase as well.

An output Q of an RS flip-flop 120 of the control circuit 103u is connected to the gate of the semiconductor relay 141u. An output Q-bar of the RS flip-flop 120 is connected to the gate of the semiconductor relay 142u. The same applies for the V-phase and the W-phase as well.

Other configurations of the winding switching device 100A according to the second embodiment are similar to those of the winding switching device 100 according to the first embodiment, and therefore identical components are denoted by identical reference numerals and description thereof is omitted.

In the second embodiment, the control device 50 sets the value of the switching command signal to Low when the windings 24u, 25u, 24v, 25v, 24w, and 25w of the motor 20 are to be put in the full connection state, and sets the value of the switching command signal to High when the windings 24u, 25u, 24v, 25v, 24w, and 25w are to be put in the partial connection state.

When the windings are in the full connection state, the output Q becomes Low and the output Q-bar becomes High at the timing when the zero crossing detection signal and the switching command signal both become High. Accordingly, the semiconductor relay 141u changes from the on state to the off state, and the semiconductor relay 142u changes from the off state to the on state. The same applies for the V-phase and the W-phase as well. For this reason, the connection state of the windings 24u, 25u, 24v, 25v, 24w, and 25w is switched from a full connection state to a partial connection state.

When the windings are in the partial connection state, the zero crossing detection signal becomes High and the switching command signal becomes Low, and at that timing, the output Q becomes High and the output Q-bar becomes Low. Accordingly, the semiconductor relay 141u changes from the off state to the on state, and the semiconductor relay 142u changes from the on state to the off state. The same applies for the V-phase and the W-phase as well. For this reason, the connection state of the windings 24u, 25u, 24v, 25v, 24w, and 25w is switched from the partial connection state to the full connection state.

As described above, the connection state of the windings 21u, 22u, 21v, 22v, 21w, and 22w can be switched between the full connection state and the partial connection state at the timing of the zero crossing points of the winding currents Iu, Iv, and Iw.

The configurations and operations of the power converter 30 and the control device 50 according to the second embodiment are similar to those of the power converter 30 and the control device 50 according to the first embodiment, and therefore description thereof is omitted.

### Third Embodiment

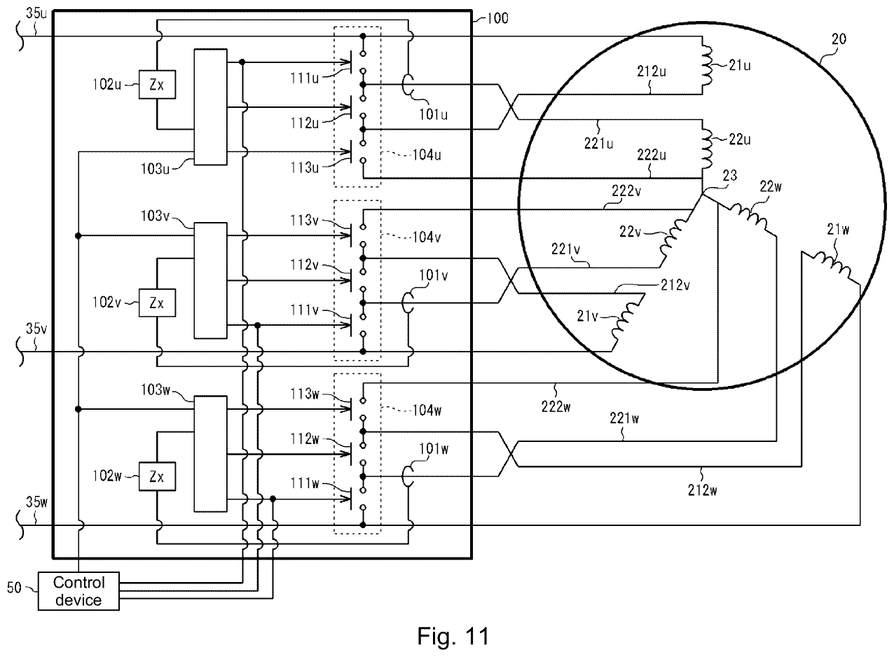

FIG. 11 is a circuit diagram showing an example of a configuration of a winding switching device according to the third embodiment. In the third embodiment, a signal indicating the timing for switching the connection state of the windings 21u, 22u, 21v, 22v, 21w, and 22w (hereinafter also referred to as a “switching timing signal”) is input to the control device 50.

The signal output from the output Q of the RS flip-flop 120 is a signal (switching timing signal) that indicates the timing for switching the connection state of the windings 21u and 22u. As shown in FIG. 11, a signal line extending from the control circuit 103u to the gate terminal of the semiconductor relay 111u branches off at an intermediate point, and the branched end is connected to the control device 50. A U-phase switching timing signal is input to the control device 50 via this signal line. Similarly, a signal line extending from the control circuit 103v to the gate terminal of the semiconductor relay 111v branches off at an intermediate point, and the branched end is connected to the control device 50. A V-phase switching timing signal is input to the control device 50 via this signal line. A signal line extending from the control circuit 103w to the gate terminal of the semiconductor relay 111w branches off at an intermediate point, and the branched end is connected to the control device 50. A W-phase switching timing signal is input to the control device 50 via this signal line. Specifically, the switching timing signal is input to the I/F 504 of the control device 50.

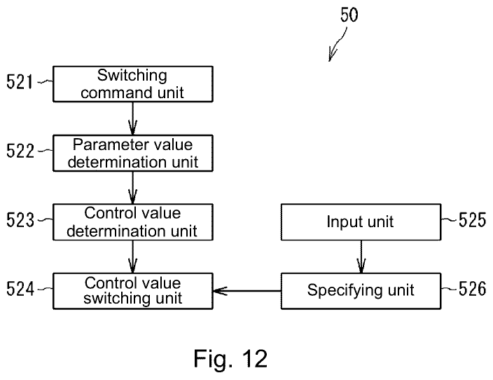

FIG. 12 is a functional block diagram showing an example of functions of the control device according to the third embodiment.

When the processor 501 executes the motor control program 510, the control device 50 executes the functions of a switching command unit 521, a parameter value determination unit 522, a control value determination unit 523, a control value switching unit 524, an input unit 525, and a specifying unit 526.

The input unit 525 receives a switching timing signal that is output by the winding switching device 100 at the timing when the winding switching device 100 executes zero crossing switching. That is, the input unit 525 receives the switching timing signals output from the control circuits 103u, 103v, and 103w of the winding switching device 100 to the gate terminals of the semiconductor relays 111u, 111v, and 111w, respectively.

The specifying unit 526 specifies the switching timing when zero crossing switching for switching the connection state of the windings 21u, 22u, 21v, 22v, 21w, and 22w from a series connection state to a parallel connection state or from a parallel connection state to a series connection state at the zero crossing points of the winding currents Iu, Iv, and Iw is executed. In a specific example, the specifying unit 526 specifies the switching timing based on the input of a switching timing signal in the input unit 525. For example, the specifying unit 526 can specify each of the switching timing in the U-phase, the switching timing in the V-phase, and the switching timing in the W-phase.

The control value switching unit 524 starts changing each of the n control voltage values from the first control voltage value to the second control voltage value based on the switching timing specified by the specifying unit 526. In a specific example, the control value switching unit 524 starts changing each of the U-phase control voltage value, the V-phase control voltage value, and the W-phase control voltage value from a first control voltage value to a second control voltage value at the first switching timing of the three switching timings specified by the specifying unit 526. For example, when the U-phase switching timing is the first switching timing, the control value switching unit 524 starts changing the U-phase control voltage value, the V-phase control voltage value, and the W-phase control voltage value from the first control voltage value to the second control voltage value at the U-phase switching timing.

Here, the switching period can be set to 2λ/3. As a result, at the switching timing in the W-phase, the change of the control voltage value of the U-phase, the control voltage value of the V-phase, and the control voltage value of the W-phase from the first control voltage value to the second control voltage value is complete.

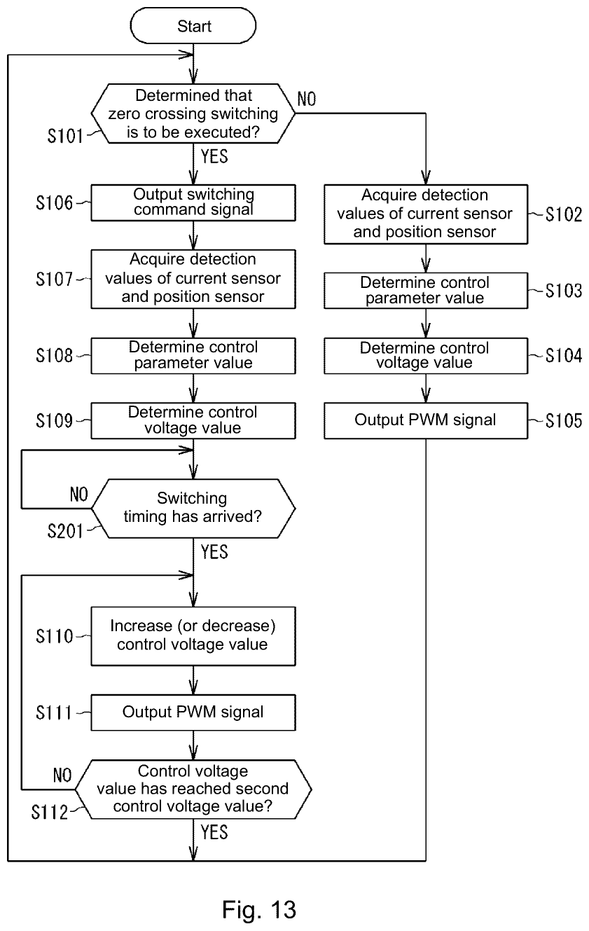

FIG. 13 is a flowchart showing an example of motor control processing performed by a control device according to the third embodiment.

Steps S101 to S109 are the same as steps S101 to S109 in the first embodiment.

In the third embodiment, a switching timing signal is output from the winding switching device 100 to the control device 50. The processor 501 determines the switching timing based on the switching timing signal.

The processor 501 judges whether or not the switching timing has arrived (step S201). If the switching timing has not arrived (NO in step S201), the processor 501 executes step S201 again.

If the switching timing has arrived (YES in step S201), the processor 501 changes the control voltage value used to generate the PWM signal by a predetermined amount (step S110). Steps S110 to S112 are the same as steps S110 to S112 in the first embodiment. This makes it possible to start gradual change of the control voltage value at the timing when the zero crossing switching is executed.

### Fourth Embodiment

The specifying unit 526 of the control device 50 according to the fourth embodiment detects the zero crossing points of the winding currents Iu, Iv, and Iw, and estimates the switching timing based on the detected zero crossing points. For example, the specifying unit 526 can specify the waveforms of the winding currents Iu, Iv, Iw from the chronological detection values of the current sensors 33u, 33v, 33w, and detect the zero crossing points in each of the U-phase, V-phase, and W-phase.

In a specific example, the specifying unit 526 can estimate that the next zero crossing point to arrive after the switching command signal is input to the winding switching device 100 is the switching timing. For example, the specifying unit 526 can estimate the switching timing for each of the U-phase, V-phase, and W-phase.

In the fourth embodiment, the input unit 525 receives detection values of the current sensors 33u, 33v, and 33w from the winding switching device 100 instead of a switching timing signal. The specifying unit 526 detects the zero crossing points of the winding currents Iu, Iv, and Iw based on the detection values of the current sensors 33u, 33v, and 33w input to the input unit 525.

Other functions of the control device 50 according to the fourth embodiment are similar to those of the control device 50 according to the third embodiment, and therefore description thereof is omitted. Other configurations of the winding switching system according to the fourth embodiment are similar to those of the winding switching system 10 according to the first embodiment, and description thereof is omitted.

### Supplementary Note

The embodiments disclosed herein are exemplary in all respects and are not restrictive. The scope of the present disclosure is indicated not by the above-described embodiments, but by the claims, and encompasses meanings equivalent to the claims and all modifications within the scope thereof.

1. A control device for controlling an AC motor capable of switching a connection state of a plurality of windings from a first connection state to a second connection state, comprising:
a switching command unit configured to command a winding switching device configured to switch the connection state of the plurality of windings, to execute zero crossing switching for switching the connection state of the plurality of windings from the first connection state to the second connection state at a zero crossing point of current flowing through the windings; and
a control value switching unit configured to switch a control value for controlling the AC motor from a first control value to be used in the first connection state to a second control value to be used in the second connection state when the zero crossing switching is executed,
wherein the control value switching unit gradually changes the control value from the first control value to the second control value.

2. The control device according to claim 1,
wherein the AC motor is a polyphase AC motor, and
the control value switching unit synchronizes the change of each of the plurality of control values corresponding to the phases from the first control value to the second control value.

3. The control device according to claim 2,
wherein the AC motor is an n-phase AC motor (n is an integer that is 3 or more), and
the control value switching unit completes the change of each of the n control values from the first control value to the second control value after λ(n−1)/n has elapsed since the start of the change, where λ is a wavelength of the current supplied to the AC motor.

4. The control device according to claim 3, wherein the control value switching unit starts the change of each of the n control values from the first control value to the second control value at a zero crossing point of current of a first phase of the n-phase alternating current.

5. The control device according to claim 3, further including;
a specifying unit configured to specify n switching timings at which the winding switching device executes the zero crossing switching for each of the n phases,
wherein the control value switching unit starts the change of each of the n control values from the first control value to the second control value at a first switching timing among the n switching timings specified by the specifying unit.

6. The control device according to claim 1, further including:
a parameter value determination unit configured to determine a parameter value of a control parameter to be used for determining the control value; and
a control value determination unit configured to determine the control value based on the parameter value determined by the parameter value determination unit,
wherein the control value determination unit determines the first control value and the second control value, and
the control value switching unit simultaneously holds the first control value and the second control value determined by the control value determination unit, and switches the control value from the held first control value to the held second control value.

7. The control device according to claim 6,
wherein the parameter value determination unit determines a first parameter value that is a parameter value in the first connection state and a second parameter value that is a parameter value in the second connection state, and
the control value determination unit simultaneously holds the first parameter value and the second parameter value determined by the parameter value determination unit, determines the first control value based on the held first parameter value, and determines the second control value based on the held second parameter value.

8. The control device according to claim 1, wherein the control value is a voltage value of a voltage to be applied to the windings.

9. A winding switching system comprising:
an AC motor capable of switching a connection state of a plurality of windings from a first connection state to a second connection state;
a power converter configured to convert power output from a power source into AC power and supply the AC power to the AC motor;
a winding switching device configured to execute zero crossing switching for switching the connection state of the plurality of windings from the first connection state to the second connection state at a zero crossing point of current flowing through the windings; and
a control device,
wherein the control device includes:
a switching command unit configured to command the winding switching device to execute the zero crossing switching; and
a control value switching unit configured to switch a control value for controlling the AC motor from a first control value to be used in the first connection state to a second control value to be used in the second connection state, when the zero crossing switching is executed, and
the control value switching unit gradually changes the control value from the first control value to the second control value.

10. (canceled)

11. A control method for controlling an AC motor capable of switching a connection state of a plurality of windings from a first connection state to a second connection state, comprising:
a step of commanding a winding switching device configured to switch the connection state of the plurality of windings, to execute zero crossing switching for switching the connection state of the plurality of windings from the first connection state to the second connection state at a zero crossing point of current flowing through the windings; and
a step of switching a control value for controlling the AC motor from a first control value to be used in the first connection state to a second control value to be used in the second connection state when the zero crossing switching is executed,
wherein in the step of switching the control value, the control value is gradually changed from the first control value to the second control value.

12. (canceled)
